(19) United States
(12) Patent Application Publication
(10) Pub. No.: US 2015/0006920 A1
(43) Pub. Date: Jan. 1, 2015

(54) KEYBOARD CIRCUIT

(71) Applicants: FIH (Hong Kong) Limited, Kowloon (HK); SHENZHEN FUTAIHONG PRECISION INDUSTRY CO., LTD., Shenzhen (CN)

(72) Inventor: JIAN-HUI LI, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/010,553

(22) Filed: Aug. 27, 2013

(30) Foreign Application Priority Data
Jun. 28, 2013 (CN) 2013102639354

(51) Int. Cl. G06F 1/26

(52) U.S. Cl. CPC G06F 1/266
USPC 713/300

(57) ABSTRACT

A keyboard circuit includes a CPU, a plurality of keys aligned in n rows and m columns, n first resistors, m second resistors, a first voltage output terminal, a second voltage output terminal, and a detection resistor. A first contact of each of the plurality of keys in a column is electronically connected to the first voltage output terminal by a second resistor, and a second contact of each of the plurality of keys in the column is grounded by the detection resistor. The first contact of each of the plurality of keys in a row is electronically connected to the second voltage output terminal by a first resistor. The CPU is grounded by the detection resistor and the first voltage output terminal alternates with the second voltage output terminal to output a voltage under control of the CPU.

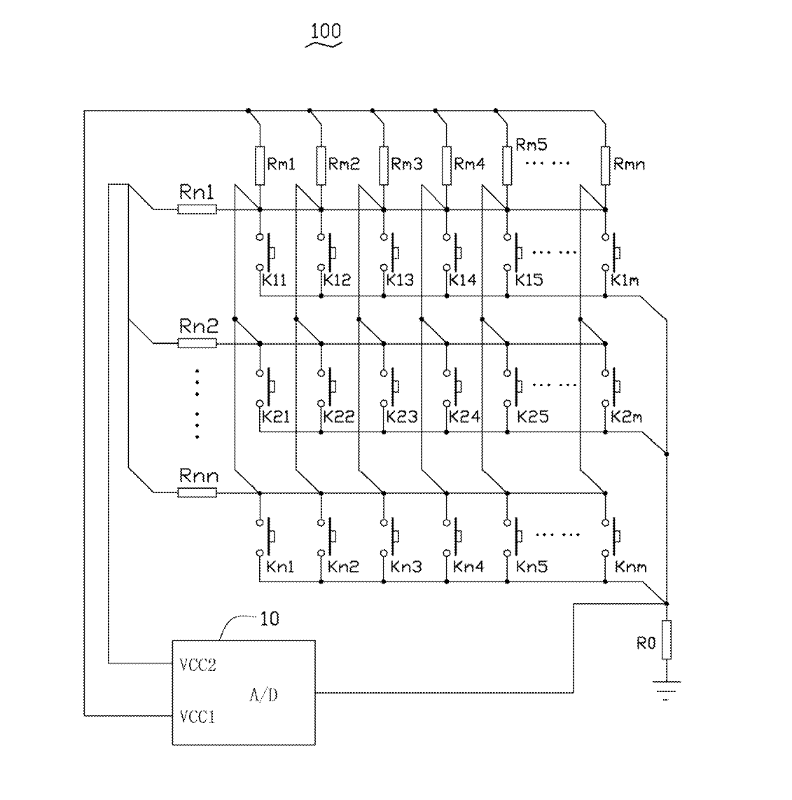

### BACKGROUND

1. Technical field

The disclosure generally relates to keyboard circuits, and particularly, to a keyboard circuit used in electronic devices.

2. Description of the Related Art

Various matrix scanning circuits are used in electronic devices, such as mobile phones and notebook computers, where the matrix scanning circuits are scanned to confirm locations of pressed keys. A typical matrix keyboard circuit includes a plurality of keys and a central processing unit (CPU). The CPU includes a plurality of row output ports and a plurality of column output ports. Two contacts of each key are connected to a row output port and a column output port, respectively by wires. In use, the CPU provides a high level voltage to the row output ports and provides a low level voltage to the column output ports.

When any key is pressed, the high level of the row output port is converted into low level and the CPU detects level changes to read corresponding procedures, resulting in scanning the keys row by row to indentify a location of the pressed key. However, in matrix keys, each wire in the same row is electronically connected to an input/output (I/O) port of the CPU, and each wire in the same column is electronically connected to another I/O port of the CPU. The more keys, the greater the number of I/O ports.

Therefore, there is room for improvement within the art.

### BRIEF DESCRIPTION OF THE DRAWINGS

Many aspects of a keyboard circuit can be better understood with reference to the following drawings. The components in the drawings are not necessarily drawn to scale, the emphasis instead being placed upon clearly illustrating the principles of the exemplary keyboard circuit.

The drawing is a schematic view of a keyboard circuit, according to an exemplary embodiment of the disclosure.

### DETAILED DESCRIPTION

The drawing is a schematic view of a keyboard circuit 100, according to an exemplary embodiment of the disclosure. The keyboard circuit 100 is used in an electronic device (not shown). The electronic device includes a plurality of keys, and the number of the keys can be defined as n×m (n and m are natural numbers). The keyboard circuit 100 includes a central processing unit (CPU) 10, keys K11-Knm, first resistors Rn1-Rnn, second resistors Rm1-Rmm, and a detection resistor R0.

The CPU 10 includes a first voltage output terminal VCC1, a second voltage output terminal VCC2, and an analog to digital terminal (A/D terminal). The keys K11-Knm are aligned in a matrix fashion of n rows and m columns A contact of each of the keys aligned in the same column (such as keys K11-Kn1) is electronically connected to the first voltage output terminal VCC1 by a second resistor (such as the second resistor Rm1 being aligned with the keys K11-Kn1). The other contact of each of the keys aligned in the same column (such as keys K11-Kn1) is electronically connected to ground by the detection resistor R0. A contact of each of the keys aligned in the same row (such as keys K11-K1m) is electronically connected to the second voltage output terminal VCC2 by a first resistor (such as the first resistor Rn1 being aligned with the keys K11-K1m). The A/D terminal is grounded by the detection resistor R0.

The CPU 10 stores first reference voltages corresponding to the n rows keys and second reference voltages corresponding to the m columns keys. When the second voltage output terminal VCC2 of the CPU 10 outputs a voltage V2, and there is no output from the first voltage output terminal VCC1, if one of the keys in the same row is pressed, voltage of the detection resistor R0 detected by the CPU 10 can be defined as the first reference voltage of the row. When the first voltage output terminal VCC1 of the CPU 10 outputs a voltage V1, and there is no output from the second voltage output terminal VCC2, if one of the keys in the same column is pressed, voltage of the detection resistor R0 detected by the CPU 10 can be defined as the column's second reference voltage. Resistances of the first resistors Rn1-Rnn, resistances of the second resistors Rm1-Rmm, and resistance of the detection resistor R0 are measured in thousands of ohms (kilohms) The resistances of the first resistors Rn1-Rnn and the resistances of the second resistors Rm1-Rmm are not equal.

In use, contacts of the keys K11-Knm are open, and the voltage of the detection resistor R0 is zero. The first voltage output terminal VCC1 of the CPU 10 outputs a voltage V1, and meanwhile there is no output from the second voltage output terminal VCC2. When one of the keys K11-Knm is pressed, the A/D terminal detects voltage variation of the detection resistor R0, and raises an interrupt in the CPU 10. The CPU 10 measures the voltage of the detection resistor R0 and compares the voltage of the detection resistor R0 with the second reference voltages stored in the CPU 10 to determine the column in which the pressed key is located.

Then the second voltage output terminal VCC2 of the CPU 10 outputs a voltage V2, and meanwhile there is no output from the first voltage output terminal VCC1. The CPU 10 measures the voltage of the detection resistor R0 and compares the voltage of the detection resistor R0 with the first reference voltages stored in the CPU 10 to determine the row in which the pressed key is located. The CPU 10 determines which key is pressed, and calls a program to execute function of the pressed key.

For example, the key K23 is pressed, the A/D terminal detects voltage variation of the detection resistor R0, and raises a interrupt in the CPU 10. The voltage of the detection resistor R0 measured by the CPU 10 is V=V1×R0/(R0+Rm3). The CPU 10 compares the voltage V with the second reference voltages stored in the CPU 10, to determine that the pressed key is located in column 3. Then, the CPU 10 allows the second voltage output terminal VCC2 to output a voltage V2, and meanwhile there is no output from the first voltage output terminal VCC1. The voltage of the detection resistor R0 measured by the CPU 10 is V=V2×R0/(R0+Rn2). The CPU 10 compares the voltage V with the first reference voltages stored in the CPU 10, to determine that the pressed key is located in row 2. Thus the CPU 10 determines that the key located in row 2 and column 3, that is, key K23, is pressed.

In the embodiment, the A/D terminal of the CPU 10 has a high voltage resolution, the higher voltage resolution, the smaller the voltage variation detected by the A/D terminal. If the voltage resolution of the A/D terminal is low, the resistance difference between each two of the first resistors Rn1-Rnn and the resistance difference between each two of the second resistors Rm1-Rmm are always large.

The keyboard circuit 100 can confirm the keys pressed through the A/D terminal of the CPU 10, the keyboard circuit 100 has simple structure and requires a lesser number of terminals of the CPU 10.

In another exemplary embodiment, the first voltage output terminal VCC1 and the second voltage output terminal VCC2 are two terminals of a power supply chip. The power supply chip is electronically connected to the CPU 10. The first voltage output terminal VCC1 alternates with the second voltage output terminal VCC2 to output voltage under the control of the CPU 10.

In another exemplary embodiment, the first voltage output terminal VCC1 is an output terminal of a first power source, and the second voltage output terminal VCC2 is an output terminal of a second power source. The first power source and the second power source are electronically connected to the CPU 10. The first voltage output terminal VCC1 alternates with the second voltage output terminal VCC2 to output voltage under the control of the CPU 10.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A keyboard circuit, comprising:
a central processing unit (CPU);
a plurality of keys aligned in a matrix fashion of n rows and m columns, where n and m are natural numbers;
n first resistors corresponding to the n rows keys;
m second resistors corresponding to the m columns keys;
a first voltage output terminal;
a second voltage output terminal; and
a detection resistor;
wherein a first contact of each of the plurality of keys aligned in a same column is electronically connected to the first voltage output terminal by a corresponding second resistor, a second contact of each of the plurality of keys aligned in the same column is grounded by the detection resistor; the first contact of each of the plurality of keys aligned in a same row is electronically connected to the second voltage output terminal by a corresponding first resistor; the CPU is grounded by the detection resistor and the first voltage output terminal alternates with the second voltage output terminal to output a voltage under control of the CPU.

2. The keyboard circuit as claimed in claim 1, wherein the CPU stores first reference voltages corresponding to the n rows and second reference voltages corresponding to the m columns; a voltage variation of the detection resistor raises an interrupt in the CPU and the CPU measures the voltage of the detection resistor and compares the voltage of the detection resistor with the first reference voltages and the second reference voltages to determine a location of a pressed key.

3. The keyboard circuit as claimed in claim 1, wherein resistances of the first resistors and resistances of the second resistors are not equal.

4. The keyboard circuit as claimed in claim 1, wherein the CPU comprises an analog to digital terminal which is grounded by the detection resistor.

5. The keyboard circuit as claimed in claim 1, wherein the first voltage output terminal and the second voltage output terminal are two terminals of a power supply chip, and the power supply chip is electronically connected to the CPU.

6. The keyboard circuit as claimed in claim 1, wherein the first voltage output terminal is an output terminal of a first power source, and the second voltage output terminal is an output terminal of a second power source; the first power source and the second power source are electronically connected to the CPU.

7. A keyboard circuit, comprising:
a central processing unit (CPU);
a plurality of keys aligned in a matrix fashion of n rows and m columns, n and m are natural numbers;
n first resistors corresponding to the n rows;
m second resistors corresponding to the m columns;
a first voltage output terminal electronically connected the m second resistors;
a second voltage output terminal electronically connected the n first resistors; and
a detection resistor;
wherein each first resistor is connected to the detection resistor by any one of the keys located in a same row with the first resistor; each second resistor is connected to the detection resistor by any one of the keys located in a same column with the second resistor; the CPU is grounded by the detection resistor and the first voltage output terminal alternates with the second voltage output terminal to output a voltage under control of the CPU.

8. The keyboard circuit as claimed in claim 7, wherein the CPU stores first reference voltages corresponding to the n rows and second reference voltages corresponding to the m columns; a voltage variation of the detection resistor raises an interrupt in the CPU and the CPU measures the voltage of the detection resistor and compares the voltage of the detection resistor with the first reference voltages and the second reference voltages to determine a location of a pressed key.

9. The keyboard circuit as claimed in claim 7, wherein resistances of the first resistors and resistances of the second resistors are not equal.

10. The keyboard circuit as claimed in claim 7, wherein the CPU comprises an analog to digital terminal which is grounded by the detection resistor.

11. The keyboard circuit as claimed in claim 7, wherein the first voltage output terminal and the second voltage output terminal are two terminals of a power supply chip, and the power supply chip is electronically connected to the CPU.

12. The keyboard circuit as claimed in claim 7, wherein the first voltage output terminal is an output terminal of a first power source, and the second voltage output terminal is an output terminal of a second power source; the first power source and the second power source are electronically connected to the CPU.

13. A keyboard circuit, comprising:
a central processing unit (CPU) comprising a first voltage output terminal and a second voltage output terminal;
a plurality of keys aligned in a matrix fashion of n rows and m columns, n and m are natural numbers;
n first resistors corresponding to the n rows;
m second resistors corresponding to the m columns; and
a detection resistor;
wherein a first contact of each of the plurality of keys aligned in a same column is electronically connected to the first voltage output terminal by a corresponding second resistor, a second contact of each of the plurality of keys aligned in the same column is grounded by the detection resistor; the first contact of each of the plurality of keys aligned in a same row is electronically connected to the second voltage output terminal by a corresponding first resistor; the CPU is grounded by the detection resistor and the first voltage output terminal alternates with the second voltage output terminal to output a voltage under control of the CPU.

14. The keyboard circuit as claimed in claim 13, wherein the CPU stores first reference voltages corresponding to the n rows and second reference voltages corresponding to the m columns; a voltage variation of the detection resistor raises an interrupt in the CPU and the CPU measures the voltage of the detection resistor and compares the voltage of the detection resistor with the first reference voltages and the second reference voltages to determine a location of a pressed key.

15. The keyboard circuit as claimed in claim 13, wherein resistances of the first resistors and resistances of the second resistors are not equal.

16. The keyboard circuit as claimed in claim 13, wherein the CPU comprises an analog to digital terminal which is grounded by the detection resistor.
